(19) United States
(12) Patent Application Publication
(10) Pub. No.: US 2013/0304671 A1
(43) Pub. Date: Nov. 14, 2013

(54) Factor Risk Models with Multiple Specific Risk Estimates

(71) Applicant: Anthony A. Renshaw, New York, NY (US)

(72) Inventor: Anthony A. Renshaw, New York, NY (US)

(73) Assignee: AXIOMA, INC., New York, NY (US)

(21) Appl. No.: 13/892,644

(22) Filed: May 13, 2013

Related U.S. Application Data
(60) Provisional application No. 61/645,678, filed on May 11, 2012.

(51) Int. Cl. G06Q 40/06

(52) U.S. Cl. CPC G06Q 40/06
USPC 705/36 R

(57) ABSTRACT

Construction of factor risk models that more advantageously predict the future volatility of returns of a portfolio of securities such as stocks, bonds, or the like is addressed. More specifically, factor risk models with more than one estimate of specific risk or, alternatively an original specific risk estimate together with a set of specific risk differences derived from more than one estimate of specific risk.

### RELATED APPLICATIONS

The present application claims the benefit of U.S. Ser. No. 61/645,678 filed May 11, 2012 which is incorporated herein by reference in its entirety.

### FIELD OF INVENTION

The present invention relates generally to the estimation of the risk, or active risk, of an investment portfolio using factor risk models. More particularly, it relates to improved computer based systems, methods and software for more accurate estimation of the risk or active risk of an investment portfolio by providing more than one estimate of specific risk or specific variance for all assets covered by a factor risk model. The invention provides practitioners with actionable information for managing and rebalancing their investment portfolios.

### BACKGROUND OF THE INVENTION

A challenge for commercial risk model vendors is to produce risk models that predict future volatility, or, in other words, accurately predict the realized risk. FIG. 1 shows a plot of predicted total risk 202 from a global factor risk model and one month forward looking realized total risk 200 for a broad global benchmark portfolio. As can be seen in FIG. 1, risk model predictions are relatively good at predicting the overall level of future realized risk, although the predicted risk is typically smoother and less reactive than realized risk.

Commercial factor risk models employ several well known mathematical modelling techniques for estimating the risk of a portfolio of financial assets such as securities. Investment practitioners then use these factor risk models to strategically invest a fixed amount of wealth given a large number of financial assets in which to potentially invest; or to manage the risk of a set of investments; or to construct a new portfolio that optimally manages the trade offs in risk and return.

For example, mutual funds often estimate the active risk associated with a managed portfolio of securities, where the active risk is the risk associated with portfolio allocations that differ from a benchmark portfolio. Often, a mutual fund manager is given a “risk budget”, which defines the maximum allowable active risk that he or she can accept when constructing a managed portfolio. Active risk is also sometimes called portfolio tracking error. Portfolio managers may also use numerical estimates of risk as a component of performance contribution, performance attribution, or return attribution, as well as, other ex-ante and ex-post portfolio analyses. See for example, R. Litterman, Modern Investment Management: An Equilibrium Approach, John Wiley and Sons, Inc., Hoboken, N.J., 2003 (Litterman), which gives detailed descriptions of how these analyses make use of numerical estimates of risk and which is incorporated by reference herein in its entirety.

Another use of numerically estimated risk is for optimal portfolio construction. One example is mean-variance portfolio optimization as described by H. Markowitz, “Portfolio Selection”, Journal of Finance 7(1), pp. 77-91, 1952 which is incorporated by reference herein in its entirety. In mean-variance optimization, a portfolio is constructed that minimizes the risk of the portfolio while achieving a minimum acceptable level of return. Alternatively, the level of return is maximized subject to a maximum allowable portfolio risk. The family of portfolio solutions solving these optimization problems for different values of either minimum acceptable return or maximum allowable risk is said to form an “efficient frontier”, which is often depicted graphically on a plot of risk versus return. There are numerous, well known, variations of mean-variance portfolio optimization that are used for portfolio construction. These variations include methods based on utility functions, Sharpe ratio, and value at risk.

Suppose that there are N assets in an investment portfolio and the weight or fraction of the available wealth invested in each asset is given by the N-dimensional column vector w. These weights may be the actual fraction of wealth invested or, in the case of active risk, they may represent the difference in weights between a managed portfolio and a benchmark portfolio as described by Litterman. The risk of this portfolio is calculated, using standard matrix notation, as

V=w^{T}Qw (1)

where V is the portfolio variance, a scalar quantity, and Q is an N×N positive semi-definite matrix whose elements are the variance or covariance of the asset returns. Risk or volatility is given by the square root of V.

The individual elements of Q are the expected covariances of security returns and are difficult to estimate. For N assets, there are N(N+1)/2 separate variances and covariances to be estimated. The number of securities that may be part of a portfolio, N, is often over one thousand, which implies that over 500,000 values must be estimated. Risk models typically cover all the assets in the asset universe, not just the assets with holdings in the portfolio, so N can be considerably larger than the number of assets in a managed or benchmark portfolio.

To obtain reliable variance or covariance estimates based on historical return data, the number of historical time periods used for estimation should be at least the same order of magnitude as the number of assets, N. Often, there may be insufficient historical time periods. For example, new companies and bankrupt companies have abbreviated historical price data and companies that undergo mergers or acquisitions have non-unique historical price data. As a result, the covariances estimated from historical data can lead to matrices that are numerically ill conditioned. Such covariance estimates are of limited value.

Factor risk models were developed, in part, to overcome these shortcomings. Factor risk models also are advantageous because they represent the dense matrix Q using a sparse representation, which is easier to store and manipulate in a computer. See for example, R. C. Grinold, and R. N. Kahn, Active Portfolio Management: A Quantitative Approach for Providing Superior Returns and Controlling Risk, Second Edition, McGraw-Hill, New York, 2000, which is incorporated by reference herein it its entirety, and Litterman.

Factor risk models represent the expected variances and covariances of security returns using a set of M factors, where M is much less than N, that are derived using statistical, fundamental, or macro-economic information or a combination of any of such types of information. Given exposures of the securities to the factors and the covariances of factor returns, the covariances of security returns can be expressed as a function of the factor exposures, the covariances of factor returns, and a remainder, called the specific risk of each security. Factor risk models typically have between 20 and 80 factors. Even with 80 factors and 1000 securities, the total number of values that must be estimated is just over 85,000, as opposed to over 500,000.

In a factor risk model, the covariance matrix Q is modelled using the sparse representation

Q=B^{T}ΣB+Δ² (2)

where B is an N×M matrix of factor exposures, E is an M×M matrix of factor-factor covariances, and Δ² is a matrix of specific variances. Normally, Δ² is assumed to be diagonal. When Δ² is diagonal, the diagonal elements represent the specific variance of each asset and the square root of the diagonal elements gives the specific risk of each asset. The specific risk is also referred to as the idiosyncratic risk. Of course Δ² may not be diagonal, in which case the specific covariance matrix Δ² is a matrix. The invention disclosed here does not distinguish those cases, although the diagonal case is far more common.

The factor-factor covariance matrix Σ is typically estimated from a time series of historical factor returns, fₜ, for each of the M factors, while the specific variances are estimated from a time series of historical specific returns. The specific returns are simply the total asset returns minus the matrix product of the factor exposures and the factor returns.

In existing commercially available factor risk models, there is only one estimate of Δ², the vector of specific variances for all assets covered by the factor risk model. Or, equivalently, commercial factor risk model vendors may only provide one estimate of specific risk, which is the square root of the diagonal of Δ² when Δ² is diagonal. Existing commercial factor risk model vendors choose a single preferred method to compute the variance or standard deviation of the time series of specific returns, and the result of that computation is what is supplied to their customers in the factor risk model.

Virtually all commercial factor risk models estimate the specific variance using an exponentially weighted estimate of variance. The use of exponential weighting helps with the stability and responsiveness of the risk model estimates since the weights place greater emphasis on current observations. Suppose that the time series of T specific returns is given by

\tilde{ε}ₜ={εₜ,εₜ₋₁,εₜ₋₂, . . . ,ε_{t-T+1}} (3)

and a corresponding series of exponentially decaying weights is formed

\tilde{w}ₜ={wₜ,wₜ₋₁,wₜ₋₂, . . . ,w_{t-T+1}} (4)

where

δ=2^{-1/H}wₜ₋ₖ=δ^{k}(1−δ)/(1−δ^{T}) for k=0, . . . ,T−1 (5)

H is the half-life parameter which indicates the number of time periods required for the exponential weighting to be reduced by half. By construction, the sum of the weights is one.

One can then estimate the variance of the time series using these weights. That is, the predicted variance is

E[var(εₜ₊₁)|ₜ]≡\hat{Δ}ₜ₊₁²=Var(\tilde{w}ₜ,\tilde{ε}ₜ) (6)

This is frequently seen expressed in the RiskMetrics™ specification in which the half-life is reformulated as a decay factor λ. See, for example, J. Longerstaey and M. Spencer, RiskMetrics™—Technical Document, Morgan Guaranty Trust Company, New York, 4th ed., 1996, which is incorporated by reference herein it its entirety. Equation (6) can be rewritten as:

\hat{Δ}ₜ₊₁²=λΔₜ²+(1−λ)εₜ² (7)

Ease and speed of computation, robustness, and parsimony have largely been responsible for the widespread adoption of exponentially weighted covariance estimates in commercial factor risk models. It is generally accepted that exponential weighting generally improves the accuracy and quality of the risk model.

There are, of course, a number of ways to improve the accuracy and responsiveness of the estimate of specific variance. For example, U.S. patent application Ser. No. 13/503,698 filed Apr. 24, 2012, assigned to the assignee of the present application and incorporated by reference herein in its entirety, describes an approach to improve risk model prediction by correcting for non-stationary financial data.

As with most financial data, specific return data has outliers. That is, there are individual specific returns that are several standard deviations away from the observed mean value. In particular, when a company announces significant news regarding its performance, there is often an immediate, large return on the stock of that company. There are also time periods in which specific returns exhibit much less volatility, for example, than observed historically. For example, when an announcement is made that one company is negotiating to buy a second company, the stock price of the second company often trades between two well known prices: the price at the time of the announcement and the price at which the purchasing company has offered to buy the company. As the deal becomes increasingly likely, the price of the second company often hovers quite close to the announced purchase price. While the price is hovering close the announced purchase price, the volatility of the second company may be significantly less than observed historically.

### SUMMARY OF THE INVENTION

Among its several aspects, the present invention recognizes a problem with existing commercial factor risk models that provide only one estimate of specific variance or specific risk for each investible asset is that that estimate cannot adequately distinguish a specific risk value driven by a long history of stationary and similar specific returns versus a specific risk that is dominated either by a large, single specific return by a prolonged time period in which the trading of that asset was driven largely by news about that company's potential acquisition, or the like.

Different investors may want to handle these different investment opportunities differently. For example, event-driven traders will want to quickly identify companies whose prices are being driven largely by news and events, and then possibly invest in either the company being acquired or the company doing the acquisition. However, buy-and-hold investors with a long investment horizon may wish that their investment allocations be relatively stable or slowly evolving even when significant news is announced.

A specific historical example illustrates the problems just described. FIG. 2 shows a table 204 of daily data for the S & P 500 Index and for Kellogg Company, a company traded on the New York Stock Exchange from Jan. 31, 2012 to Feb. 17, 2012. During this time period, the S & P 500 Index had daily returns ranging from −0.69% to +1.46%. During that same time, Kellogg had returns ranging from −0.95% to 5.11%. In particular, there were two days on which Kellogg had substantially better performance than the market as a whole as represented by the S & P 500. On Feb. 2, 2012, senior management of Kellogg released an earnings announcement indicating that the fourth quarter income had increased 23%. As a result of this good news, the stock price of Kellogg rose 2.60%. Then, on Feb. 15, 2012, senior management of Kellogg announced that it had bought the Pringles™ product line from Proctor & Gamble for $2.7 billion. As a result of this further good news, the stock price of Kellogg rose 5.11%. This large return is more than three times the standard deviation of returns shown on this table. In other words, it is an outlier driven by news announced for this company.

In FIG. 3, a table 206 shows how the specific risk provided by Axioma's commercial factor risk models varied over the same time period. Axioma currently provides a large number of factor risk models that include Kellogg. This includes Axioma's US equity factor risk models, Axioma's North American equity factor risk model, and Axioma's Global equity factor risk model. For each geography, Axioma provides four different factor risk models: a fundamental factor, medium horizon risk model; a statistical factor, medium horizon risk model; a fundamental factor, short horizon risk model; and a statistical factor, short horizon risk model. The results 206 show the changes in the fundamental factor medium horizon risk model (“Fund RM”) and the statistical factor medium horizon risk model (“Stat RM”).

As can be seen, on both dates with large positive returns, Feb. 2, 2012 and Feb. 15, 2012, the specific risk estimate increased substantially for both risk models. This example illustrates that a single day with a large return can produce noticeable changes in specific risk.

FIG. 4 illustrates how changes in the risk model and, in particular, changes in the specific risk estimate, can lead to changes in an investment allocation. The table 208 shows the results of using Axioma factor risk models to create a portfolio of long-only stocks taken from the S & P 500 that has the minimum possible total risk. Commercial Axioma software was used to set up and solve this portfolio optimization or portfolio construction problem.

On all days shown and for both risk models, the minimum total risk portfolio included an allocation in Kellogg. That weight (Wgt) or fraction of the total investment allocated to Kellogg is shown in table 208 for the medium horizon fundamental factor risk model (“Fund RM”) and for the medium horizon statistical factor risk model (“Stat RM”). As can be seen, the allocation changes on each day, typically by a relatively small amount. On Feb. 2, 2012, the date of the earnings announcement and the 2.60% return on Kellogg's stock price, the allocation in the minimum total risk portfolio increased a bit more than on previous days. Then, on Feb. 15, 2012, the date of the purchase of Pringles and the 5.11% return on Kellogg's stock price, the allocation decreased. For the statistical factor risk model, the allocation went from 12.23% to 9.13%, a 25% reduction in the investment.

These results illustrate that the impact of outliers and company specific news on the risk predictions of a factor risk model and the asset allocations derived by using those factor risk models can be significant and, as illustrated in table 208, may not always be in the same or most intuitive direction. That is, the large positive stock price return on Feb. 2, 2012 increased the allocation in the minimum total risk portfolio for both factor risk models, while the large positive stock price return on Feb. 15, 2012 decreased the allocation in the minimum total risk portfolio.

Limiting the factor risk model to one specific risk or specific variance estimate per asset does not provide enough information to investors to distinguish whether the changes in specific risk, total risk, active risk, or asset allocations are driven by sustained performance or by individual outlier returns or company specific news.

The present invention recognizes that factor risk models with only one specific risk or specific variance estimate for each asset, do not easily distinguish companies with significant news from those without.

One goal of the present invention, then, is to provide more than one estimate of specific risk or specific variance as part of a factor risk model. Comparison of the different specific risk or variance estimates for a given asset will help investors easily distinguish companies with significant news from those without.

Another goal to be solved by the present invention is to provide an easy way for investors to control how quickly the investment risk predictions and their investment allocations change when news is announced for a particular company. That is, by selecting and utilizing different specific risk estimates with different levels of reactiveness to the returns of a single day, investors can obtain investment results that match their investment needs.

Another goal to be solved by the present invention is to provide investors with different specific risk estimates so that investors may choose the risk estimate that best suits his or her investment goals.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates predicted versus realized risk for a broad global portfolio from 2000 to 2010;

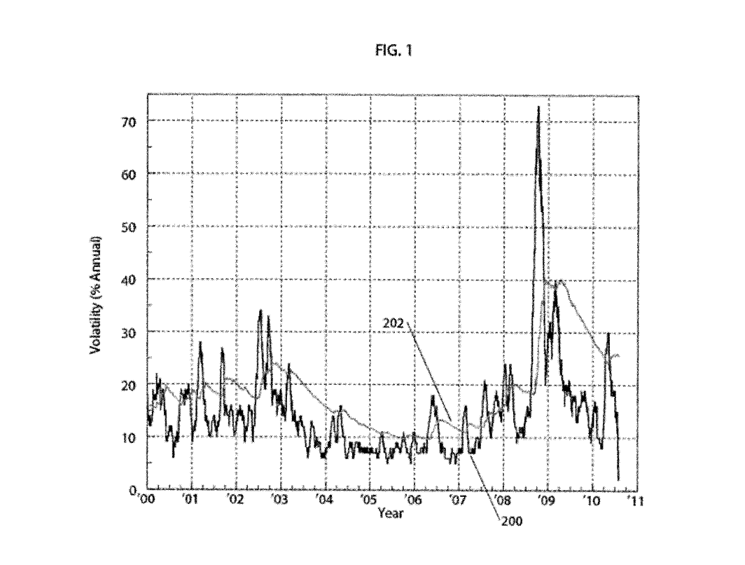

FIG. 2 illustrates the daily return history of the S & P 500 Index and Kellogg from Jan. 31, 2012 to Feb. 17, 2012;

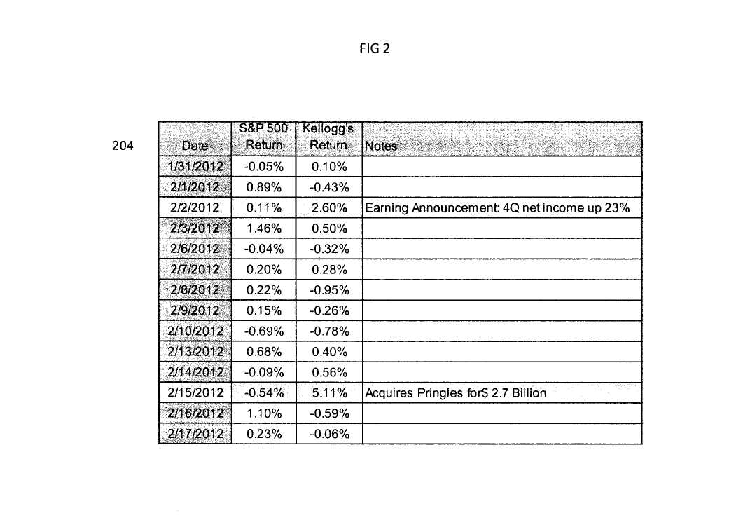

FIG. 3 illustrates the daily changes in specific risk for Kellogg as predicted by two Axioma factor risk models from Jan. 31, 2012 to Feb. 17, 2012;

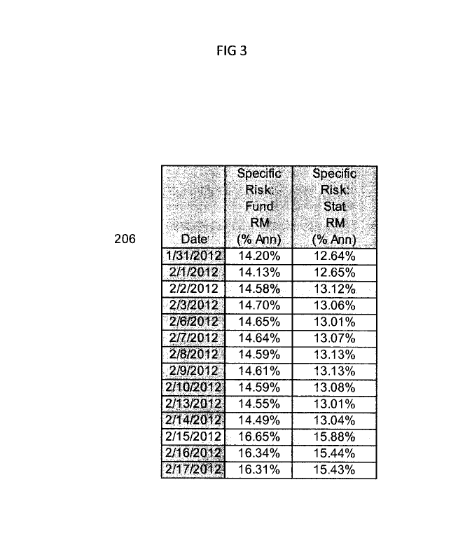

FIG. 4 illustrates the daily changes in the allocation in Kellogg as predicted by constructing a long-only portfolio using stocks in the S & P 500 using two Axioma factor risk models from Jan. 31, 2012 to Feb. 17, 2012;

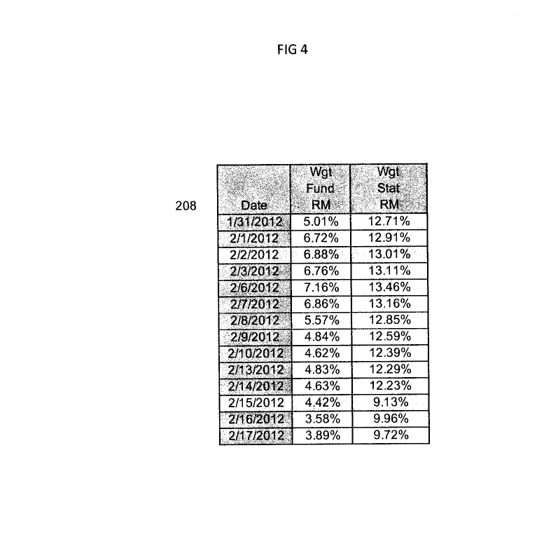

FIG. 5 shows a computer based system which may be suitably utilized to implement the present invention;

FIG. 6 show backtest performance results using different specific risk estimates over the Russell 1000 investment universe; and

FIG. 7 show backtest performance results using different specific risk estimates over the Russell 2000 investment universe.

### DETAILED DESCRIPTION

The present invention may be suitably implemented as a computer based system, in computer software which is stored in a non-transitory manner and which may suitably reside on computer readable media, such as solid state storage devices, such as RAM, ROM, or the like, magnetic storage devices such as a hard disk or floppy disk media, optical storage devices, such as CD-ROM or the like, or as methods implemented by such systems and software.

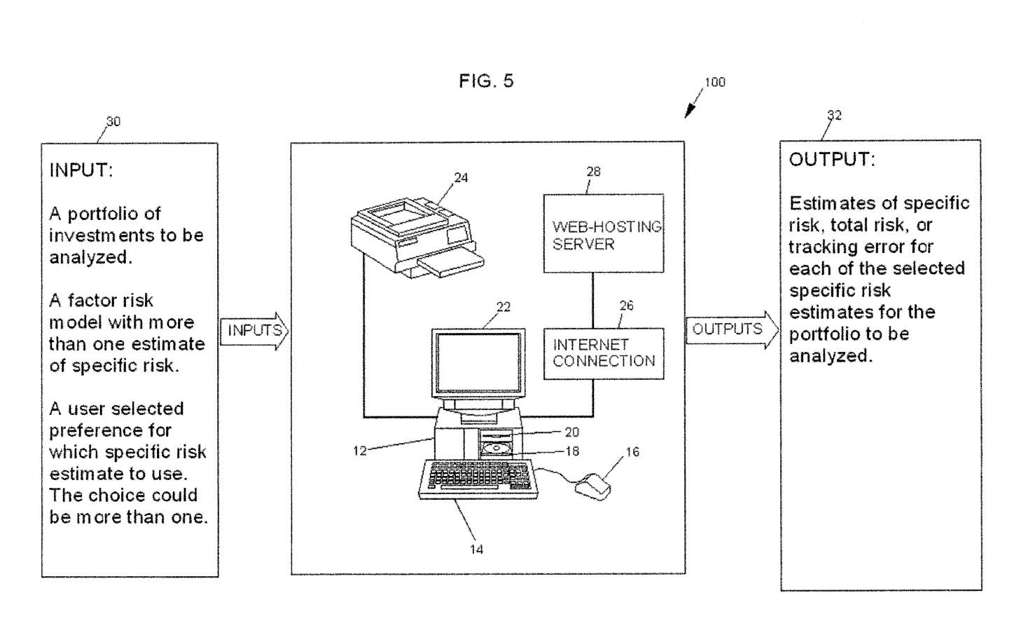

FIG. 5 shows a block diagram of a computer system 100 which may be suitably used to implement the present invention. System 100 is implemented as a computer 12 including one or more programmed processors, such as a personal computer, workstation, or server. One likely scenario is that the system of the invention will be implemented as a personal computer or workstation which connects to a server 28 or other computer through an Internet connection 26. In this embodiment, both the computer 12 and server 28 run software that when executed enables the user to input instructions and calculations on the computer 12, send the input for conversion to output at the server 28, and then display the output on a display, such as display 22, or the output is printed out, using a printer, such as printer 24, connected to the computer 12. The output could also be sent electronically through the Internet connection 26. In another embodiment of the invention, the entire software is installed and runs on the computer 12, and the Internet connection 26 and server 28 are not needed. In still a further embodiment, the Internet connection is replaced with a local area network. As shown in FIG. 5 and described in further detail below, the system 100 includes software that is run by the central processing unit of the computer 12. The computer 12 may suitably include a number of standard input and output devices, including a keyboard 14, a mouse 16, CD-ROM drive 18, disk drive 20, monitor 22, and printer 24. It will be appreciated, in light of the present description of the invention, that the present invention may be practiced in any of a number of different computing environments without departing from the spirit of the invention. For example, the system 100 may be implemented in a network configuration with individual workstations connected to a server. Also, other input and output devices may be used, as desired. For example, a remote user could access the server with a desktop computer, a laptop utilizing the Internet or with a wireless handheld device such as an IPad™, IPhone™, IPod™, Blackberry™, Treo™, or the like.

One embodiment of the invention has been designed for use on a stand-alone personal computer running in Windows (Microsoft XP, Vista, Windows 7). Another embodiment of the invention has been designed to run on a Linux-based server system.

According to one aspect of the invention, it is contemplated that the computer 12 will be operated by a user in an office, business, trading floor, classroom, or home setting.

As illustrated in FIG. 5, and as described in greater detail below, the inputs 30 may suitably include a portfolio of investments to be analyzed, a factor risk model that covers the assets in said portfolio where said factor risk model has more than one estimate of specific risk, and a user selected choice for which specific risk estimate to use. The user choice could be to use more than one specific risk estimate. If more than one specific risk estimate is chosen, then there will be output for each specific risk estimate chosen. For example, a portfolio manager may wish to see the risk in his portfolio using two distinct specific risk models, one with a rapid response to company specific news and unusual daily asset returns, the other that is relatively insensitive to company specific new and unusual daily asset returns. By comparing these two risk estimates for his or her complete portfolio, he or she will be able to assess how vulnerable the portfolio has been or may be in the future to company specific news announcements.

As further illustrated in FIG. 5, and as described in greater detail below, the system outputs 32 may suitably include estimates of specific risk, total risk, or tracking error for each of the selected specific risk estimates for the portfolio to be analyzed.

In another embodiment of the invention, the input consists of a universe of potential investments, a portfolio construction method, together with a risk model with more than one specific risk estimate and a user selected choice of specific risk. The output of this system would be a portfolio constructed using the portfolio construction method that utilized the factor risk model and the user specified choice or choices of specific risk.

The output information may appear on a display screen of the monitor 22 or may also be printed out at the printer 24. The output information may also be electronically sent to an intermediary for interpretation. For example, risk predictions for many portfolios can be aggregated for multiple portfolio or cross-portfolio risk management. Or, alternatively, trades based, in part, on the factor risk model predictions, may be sent to an electronic trading platform. Other devices and techniques may be used to provide outputs, as desired.

With this background in mind, we turn to a detailed discussion of the invention and its context. First, begin with a time series of T specific returns \tilde{ε}ₜ={εₜ, εₜ₋₁, εₜ₋₂, . . . , ε_{t-T+1}} for a single asset and a set of corresponding weights \tilde{w}ₜ={wₜ, wₜ₋₁, wₜ₋₂, . . . , w_{t-T+1}}. The weights need not necessarily decay exponentially, nor do the weights necessarily sum to one. A procedure for estimating the variance of the specific returns is selected that properly incorporates the weighting scheme. We denote the “Simple” estimate of variance as the estimate using the chosen original weights \tilde{w}ₜ and specific returns \tilde{ε}ₜ:

Δ_{Simple}²=Var(\tilde{w}ₜ,\tilde{ε}ₜ)

This is one estimate of the specific variance. For other estimates, the tools of robust statistics are utilized. For example, The MathWorks website http://www.mathworks.com/help/toolbox/stats/robustfit.html gives a summary of eight robust methods that methodically downweight the influence of outliers. These eight methods include the Andrews, Bisquare, Cauchy, Fair, Huber, Logistic, Talwar, and Welsch methods. Here, two methods are discussed and analyzed, the Bisquare and Huber methods, but other methods that deemphasized or even emphasized outlier weights could also be employed if desired.

For both methods analyzed here, a metric is adopted to measure the variability of the specific returns. The standard deviation of the specific returns may be suitably used. However, for this analysis, the weighted, median, absolute deviation of the specific returns is used:

s=MAD(\tilde{w}ₜ,\tilde{ε}ₜ)

For the alternative methods, the weights used to compute the variance are then modified according to how the specific returns compare with s. For the Huber case, the modified weights are given by

$${r}_{t - k } = ( {ɛ}_{t - k} - {ɛ}_{med} ) / ( 1.345 s )$$

$${w}_{t - k}^{Huber} = \{ \begin{matrix}{w}_{t - k} , & \vert {r}_{t - k} \vert \leq 1 \\ {w}_{t - k} {\vert {r}_{t - k} \vert}^{- 1} & \vert {r}_{t - k} \vert > 1\end{matrix}$$

where ε_{med} is the median specific return computed using the original weights. Often, ε_{med} is simply assumed to be zero. When then have

Δ_{Huber}²=Var(\tilde{w}ₜ^{Huber},\tilde{ε}ₜ)

For the Bisquare case,

$${r}_{t - k} = ( {ɛ}_{t - k} - {ɛ}_{med} ) / ( 4.685 s )$$

$${w}_{t - k}^{Bisquare} = \{ \begin{matrix}{w}_{t - k} ( 1 - {r}_{t - k}^{2} ) , & \vert {r}_{t - k} \vert \leq 1 \\ 0 , & \vert {r}_{t - k} \vert > 1\end{matrix} \\ and \\ {Δ}_{Bisquare}^{2} = Var ( {\tilde{w}}_{t}^{Bisquare} , {\tilde{ɛ}}_{t} )$$

are used.

For a given set of asset returns, three different methods are identified for estimating the specific variance of each asset. In the invention described herein, these different estimates of specific variance are provided, and allow the user to decide which works best for his or her investment situation. That is, the current state of the art is to provide a factor risk model by supplying the matrix B, the matrix Σ, and the vector Δ². The invention describes here provide the set of data {B, Σ, Δ², Δ_{Simple}², Δ_{Huber}², Δ_{Bisquare}²}. Alternatively, the invention could specify the alternative estimates in terms of differences from the original estimate, {B, Σ, Δ², Δ_{Simple}²−Δ², Δ_{Huber}²−Δ², Δ_{Bisquare}²−Δ²}. Although mathematically equivalent, the differences may be more useful since many investors may be primarily interested in identifying assets with large differences in specific variance and either including or excluding them from their portfolio.

The use of these three different estimates is now illustrated for the case in which the investor is investing in US equities. The data and factor risk model data currently provided by Axioma is used as a starting point. That model has an original estimate of specific risk. Then, the three different specific risk values given above—Δ_{Simple}², Δ_{Huber}², Δ_{Bisquare}²—for the asset data. For each estimate, we use the preceding 1250 trading days (T=1250), which covers approximately five years of data. We also choose a half-life of 125 trading days (H=125).

Two sets of backtests were performed, the first using the Russell 1000 as the universe of investible assets, the second using the Russell 2000 as the universe of investible assets. The backtests rebalance the portfolio monthly from Dec. 31, 1997 to Feb. 29, 2012 on the last trading day of the month. Three different portfolio construction strategies are considered:

In the first portfolio construction strategy, a long only portfolio is constructed from assets in the investible universe that minimize the total risk of the portfolio.

In the second portfolio construction strategy, a long only portfolio is constructed of at most 20 different assets from assets in the investible universe that minimizes the tracking error to the underlying benchmark (either the Russell 1000 or the Russell 2000).

In the third portfolio construction strategy, a long only portfolio is constructed of at most 10 different assets from assets in the investible universe that minimizes the tracking error to the underlying benchmark (either the Russell 1000 or the Russell 2000).

The reason for using these three different backtests is that they each create portfolios with different average levels of specific risk. In the first case, the specific risk of the portfolio is approximately one third the factor risk for the portfolio. Hence, specific risk is an important by not dominate contributor to the overall risk of the portfolio. In the second case, the specific risk is approximately 75% of the factor risk. In the third case, the specific risk is approximately 90% of the factor risk. Hence, the different specific risk models are expected to have the greatest impact on the last two backtests, since those portfolios are more sensitive to the specific risk model.

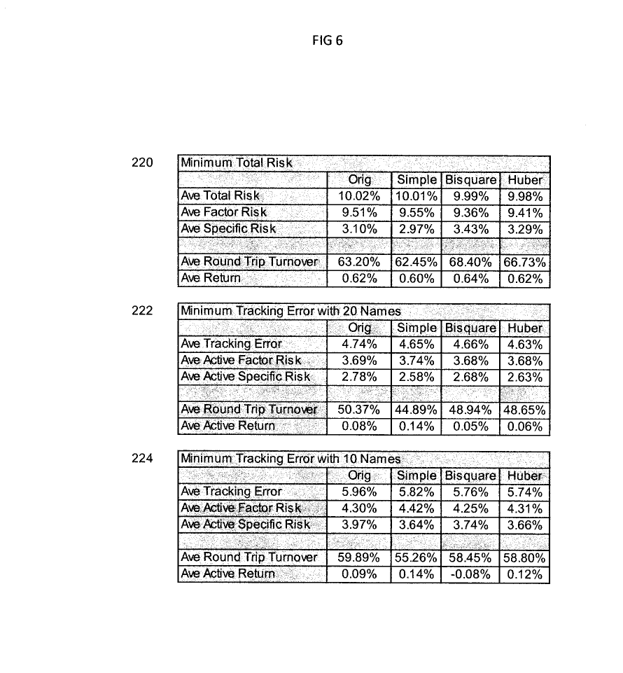

In FIG. 6, performance results are illustrated for the backtests using the Russell 1000 universe of equities. Table 220 summarizes the results for the first portfolio construction strategy, the minimum total risk case. Table 222 summarizes the results for the second portfolio construction strategy, the minimum tracking error with 20 names case. Table 224 summarizes the results for the third portfolio construction strategy, the minimum tracking error with 10 names case.

Each table displays the average total risk of the portfolio, the average factor risk of the portfolio, and the average specific risk of the portfolio. This gives a sense for how much impact the specific risk models have on the output. The table also provides two metrics to measure the performance of the backtest: the average, monthly round trip turnover and the average monthly return or active return. In general, investors seek to have lower turnover and higher average return or average active return.

Four different results are provided. The results using the existing specific variance model provided with Axioma's factor risk model are shown under the heading “Orig”. The results for the Simple, Bisquare, and Huber methods are shown under those headings.

For the first backtest, the most noticeable difference in the four different results is the round trip turnover incurred rebalancing each month. It is lowest for the Simple case (62.45%) and highest for the two robust cases (68.40% and 66.73%). This result makes sense. Since the robust methodology downweights large single day returns, which would generally increase specific risk, the robust portfolios are more likely to hold equities that have large single day returns. This will lead to additional turnover if the future returns of those companies also have those large returns. Although the Bisquare case actually has the highest average return, the differences are small (4 basis points). So in this case, the investor could choose between the Simple case, which has 6% less turnover each month relative to the Bisquare method, but underperforms by 4 basis points.

For the second backtest, more differences are seen in the four difference specific risk models, which makes sense since specific risk is more dominant in this case. In this backtest, the best performance is given by the Simple specific risk model, which has the lowest turnover and the highest average monthly active return.

For the third backtest, in which specific risk is even more dominant, the Simple specific risk model continues to outperform, once again having the lowest turnover and the highest average monthly active return.

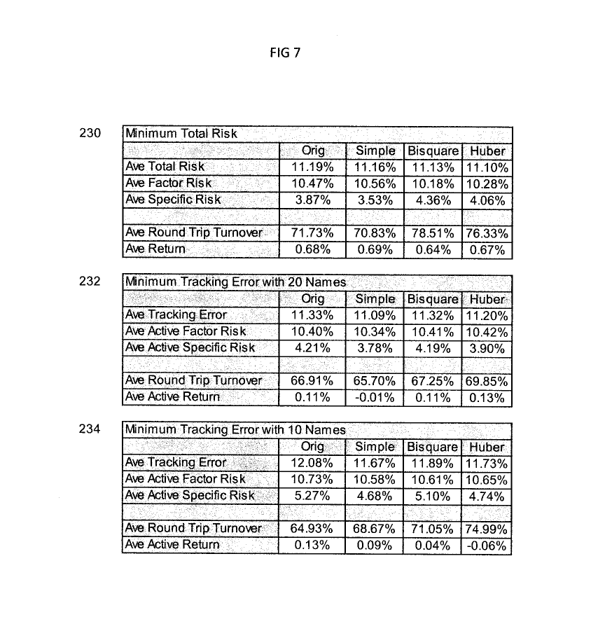

FIG. 7 provides the backtest performance summary for the Russell 2000 universe. Because of the large number of names in this universe, specific risk is less dominate in all cases when compared with the Russell 1000 results. For the Russell 2000 universe, specific risk is approximately 35%, 40%, and 50% of the factor risk in the three backtest cases, respectively. Nevertheless, performance differences are seen across the four specific risk models.

For the first backtest, shown in Table 230, the best specific risk model is the Simple model which has the lowest turnover and the highest average monthly return.

For the second backtest, shown in Table 232, the Simple specific risk model has the lowest turnover but significantly underperforms all three other models in terms of average monthly active return.

For the third backtest, shown in Table 234, the original specific risk model has the lowest turnover and the highest average monthly active return.

The results shown in FIGS. 6 and 7 illustrate that different specific risk models give noticeably different performance results. Hence, the ability to choose from more than one specific risk model is advantageous to factor risk model customers.

The backtests here were quite simple in that the only change was a change in specific risk model. It is anticipated that portfolio managers would likely use the different specific risk estimates to filter the universe of investible equities to either emphasize or deemphasize those assets with large differences in specific risk. It is also anticipated that the performance results for such a backtest would be significantly different. In such a case, having more than one specific risk model would be extremely advantageous.

While the present invention has been disclosed in the context of various aspects of presently preferred embodiments, it will be recognized that the invention may be suitably applied to other environments consistent with the claims which follow.

1. A computer-based method of using a factor risk model to estimate a risk of a portfolio of assets comprising:
electronically receiving by a programmed computer a portfolio to be analyzed defined by a N-dimensional vector for a set of N possible investment opportunities with elements corresponding to investment holdings in said portfolio;
electronically receiving by the programmed computer a factor risk model defined and calibrated for portfolios in the N investment opportunities, said factor risk model comprising a matrix of factor exposures, a matrix of factor covariances, and two or more matrices modelling either specific covariance or specific risk;
electronically receiving by the programmed computer a choice of which specific covariance or specific risk model to use, where more than one choice may be selected;
computing a risk prediction for the portfolio using the factor risk model for each specific covariance or specific risk model selected; and
electronically outputting the modified risk prediction.

2. The method of claim 1 in which the matrices of specific covariances or specific risk models are diagonal matrices so that the factor risk model need only supply vectors of specific variance or specific risk for each specific covariance model.

3. The method of claim 2 where the first specific risk model is provided as estimates of specific variance or specific risk while the other specific risk models are specified in terms of differences from the first model.

4. A computer-based method comprising:
electronically inputting a set of N possible investment opportunities;
defining a vector space of N-dimensional vectors representing portfolios in the N investment opportunities, whose vector elements correspond to investment holdings in any investment portfolio;
electronically receiving by a programmed computer a factor risk model defined and calibrated for portfolios in the N investment opportunities, said factor risk model comprising a matrix of factor exposures, a matrix of factor covariances, and two or more matrices modelling either specific covariance or specific risk;
electronically receiving by the programmed computer a choice of which specific covariance model or specific risk model to use, where more than one choice may be selected;
defining a portfolio optimization strategy for determining an optimized portfolio of investment holdings that utilizes said factor risk model and the choice or choices of which specific covariance or risk models to use;
computing the optimal portfolio using the portfolio optimization strategy utilizing the programmed computer and portfolio optimization software; and
electronically outputting the optimized portfolio.

5. The method of claim 3 in which the models of specific covariances or specific risk are diagonal matrices so that the factor risk model need only supply vectors of specific variance or specific risk for each model.

6. The method of claim 5 where the first specific risk model is provided as estimates of specific variance or specific risk while the other specific risk models are specified in terms of differences from the first model.
